(19) United States
(12) Patent Application Publication
(10) Pub. No.: US 2005/0018194 A1
(43) Pub. Date: Jan. 27, 2005

(54) Surface plasmon resonance sensor

(76) Inventors: Carsten Thirstrup, Charlottenlund (DK); Weiyong Zong, Taastrup (DK); Helmut Neff, Korsor (DK)

Correspondence Address: HARNESS, DICKEY & PIERCE, P.L.C., P.O. BOX 8910, RESTON, VA, 20195, US

(21) Appl. No.: 10/492,972

(22) PCT Filed: Oct. 7, 2002
(86) PCT No.: PCT/EP02/11115

(30) Foreign Application Priority Data
Oct. 17, 2001 (DE) 101 51 312.7

(51) Int. Cl. G01N 21/55

(52) U.S. Cl. 356/445

(57) ABSTRACT

The invention relates to a surface plasmon resonance sensor comprising a base unit (2) containing a light source (6) for generating light beams (10) and an optical sensor unit (3; 21; 31; 103; 131) for exciting surface plasmons, said sensor unit having a measuring surface (18; 29; 122; 138) that is formed by a thin metal film and that can be brought into contact with a sample (19; 123) to be measured. The aim of the invention is to provide a surface plasmon resonance sensor (1) comprising a compact optical sensor unit (3; 21; 31; 103; 131) that is easy to replace reproducible quality. This is achieved by an optical sensor unit (3; 21; 31; 103; 131) comprising a prism (12; 22; 32; 112; 132) consisting of an optically transparent material. Areas (16, 20; 23, 24; 33, 34; 118, 119; 133, 134) of said prism (12; 22; 32; 112; 132) are configured in such a way, that they focus the light beams (10′) emanating from the base unit (2) onto the measuring surface (18; 29; 122; 138). This is achieved, for example, by a convex curvature of the mirror-coated lateral surfaces or lenses that are integrated into the prism.

The invention concerns a surface plasmon resonance sensor as defined in the introductory part of claim 1.

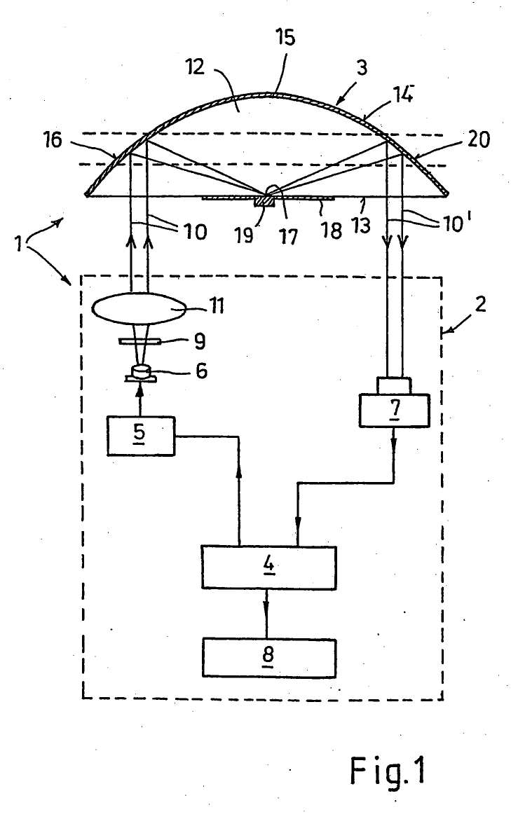

Such sensors which are also designated SPR sensors (S=Surface, P=Plasmon, R=Resonance), are known e.g. from U.S. Pat. No. 5,822,073. In that connection, FIG. 1 of that document shows a SPR sensor in which the optical sensor unit comprises a prism stump of an optically transparent material, on which prism inclined and externally mirror-coated planar lateral faces reflect the collimated and polarised white light emanating from the base unit and subsequently, following multiple reflections, hits the measuring surface formed by a thin metal film. The surface plasmon resonance thereby excited in the metal film is influenced by the sample to be analysed (analyte). Through determination of the spectral distribution of the correspondingly modulated light reflected on the metal film, the properties of the analyte are then determined.

In this arrangement, among other things, the comprehensive spectral analysis to determine the plasmon resonance is disadvantageous since additional dispersive elements or spectrographs are necessary which causes a relatively large space requirement.

EP 0 863 395 A2 describes SPR sensors in which monochromatic light is focussed through the side faces of a prism by means of lenses and onto the measuring surfaces in contact with an analyte for exciting the surface plasmon resonances. The evaluation of the reflected light beams modulated by the surface plasmon resonance is in this case carried out by measurement of the intensity of the reflected light as a function of the angle of incidence of the light hitting the metal surface. Thereby, the aperture angle of the light hitting the measuring surface overlaps the relevant range of angles of incidence.

Among other things, it is a disadvantage of this arrangement that additional lenses are necessary for focussing the light beams, which further requires relatively much space.

The invention is based on the task of indicating an SPR sensor of the type mentioned initially, said sensor working with light focussed on the measuring surface and comprising an optical sensor unit of compact design which is easily replaceable and which can be manufactured at a low price as well as with good and reproducible quality.

According to the invention, this task is solved through the characterising features of claim 1. Further particularly advantageous embodiments of the invention are described in the subclaims.

The invention is essentially based on the idea of involving partial areas of the prism to focus the light beams. This is done e.g. by the inclined side surfaces of the prism having a convex curvature, at least in the optical beam directing areas, in such a manner that the optical beams emanating from the device are focussed on the measuring surface or that the divergent beams emanating from the measuring surface are converted into collimated light.

The inclined side surfaces of the prism can have a parabolic curvature as well as a spherical curvature. In so far as a spherical curvature is preferred, it has been found to be advantageous in order to provide small dimensions of the prism, that the curvatures of the two opposing side surfaces is selected so that the spherical centres of these curvatures lie outside its axis of symmetry, but symmetrical with it.

In a further advantageous embodiment of the invention, at least one focussing lens integrated into the prism is arranged in those areas of the base surface of the prism, via which the light beams are coupled in or out, in such a manner that the light beams coupled in via the base surface and reflected on the side surfaces of the prism are focussed on the measuring surface, and/or that the reflected light beams emanating from the measuring surface are converted into collimated light.

It is furthermore conceivable to arrange focussing gratings in the area of the base surface or the mirror-coated side surfaces of the prism in question.

A further important advantage of the invention consist in the fact that coupling the light into and out of the optical sensor unit is carried out in such a manner that the beam path in question extends perpendicular to the base surface of the prism so that the optical interfaces between base unit and the optical sensor unit are unambiguously defined and permit a modularization of these units.

In order to design the optical sensor unit in the most space-saving manner, the prism can be replaced with a prism stump with base and upper surfaces arranged parallel with one another.

In the case of lenses integrated into the prism, the inclined side surfaces of the prism can either extend in a planar manner so that the lens integrated into the prism solely causes focussing of the light beams on the measuring surface, or the inclined side surfaces can also extend in a curved manner so that the focussing effect of the lens and the focussing effect of the corresponding curved side surface of the prism together causes a focussing of the light beams on the measuring surface.

As the semitransparent metal layer, a gold layer, but also a silver layer or an alloy of the two metals, can be used. The prism can for example also consist of glass or sapphire.

Furthermore, the prism stump can have a base length which allows for several reflections of the light focussed onto the measuring surface. The same applies to the modulated light arriving from the measuring surface onto the corresponding side surfaces of the prism acting as collimator.

Furthermore, the term “light” as used in the context of the present invention does not mean solely light from the visible spectrum, but quite generally means optical radiation, in particular also radiation from the infrared wavelength range.

Further details and advantages of the invention will become apparent from the following working examples explained by means of the figures. The figures show:

FIG. 1 a schematic of a SPR sensor according to the invention with a base unit and an optical sensor unit comprising a prism, where the prism has a parabolically curved limiting surface;

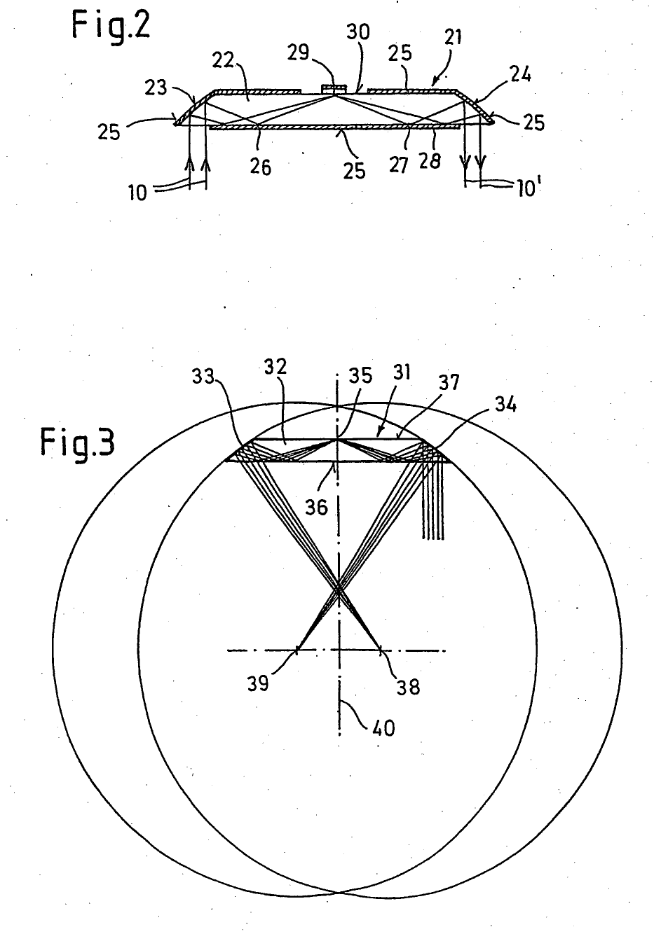

FIG. 2 is an optical sensor unit comprising a prism stump, where the side surfaces have a parabolic curvature;

FIG. 3 is a sensor unit comprising a prism stump where the side surfaces have a spherically shaped curvature;

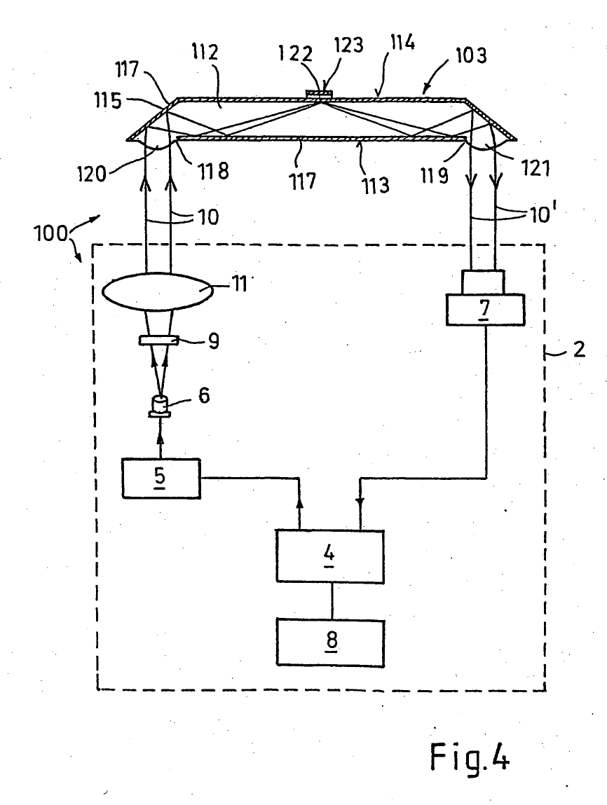

FIG. 4 is a schematic of a further working example of the invention where two focussing lenses are provided in the area of the base surface of the prism, and

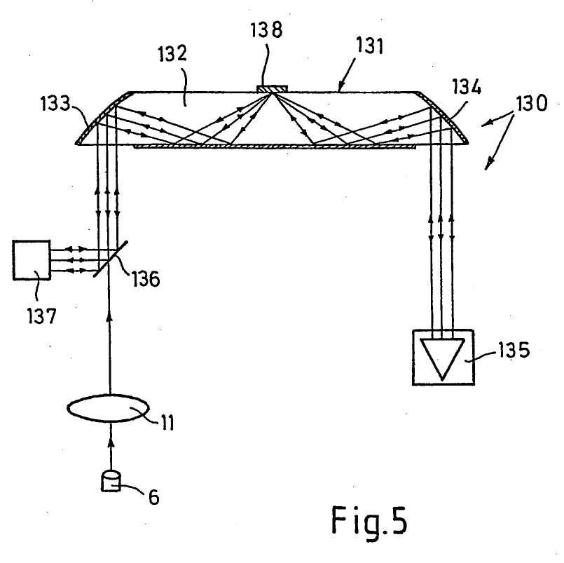

FIG. 5 is an SPR sensor with an optical sensor unit which comprises a prism with focussing side surfaces and a retroreflector coupled after the optical sensor unit.

In FIG. 1, an SPR sensor is designated with the reference number 1, said sensor consisting of a base unit 2 and an optical sensor unit 3 for the excitation of surface plasmons.

The base unit 2 comprises an electronic control and evaluation means 4 which is connected with a light emitting diode 6 generating monochromatic light via a power supply unit 5 as well as connected with a camera 7. Furthermore, a signal display 8 is coupled after the control and evaluation means 4.

A polarizer 9 for polarisation of the light beams 10 emanating from the light diode 6 as well as a collimator lens 11 are also provided in the base unit 2. The optical sensor unit 3 has essentially a prism 12, for example of acrylics or glass, with a planar base surface 13 and adjoining parabolically curved limitation surface 14 which on the outside is provided with a well-reflecting layer 15. The parabolically curved limitation surface 14 is selected in such a manner that the collimated light beams 10 arriving in the prism 12 via the base surface 13 are focussed by the first side surface 16 of the prism 12 onto a focal point 17 located centrally on the base surface 13, in which area a thin metal film 18 of gold forming the measuring surface is arranged. The thin metal film 18 is brought into contact on the outside with an analyte 19 (e.g. located in a measuring cell).

Through the optical excitation of the surface plasmon resonance, an amplified optical absorption occurs so that the reflected radiation 10′ exhibits a sharp minimum within a small defined aperture angle range of the beams 10 hitting the measuring surface, the form and exact position of the minimum depending of the analyte 19 to be measured. The light beams 10′ totally reflected at the metal film and modulated by the surface plasmon resonances at the interface are subsequently again converted into collimated light by the second side surface 20 of the prism 12 and arrive in the camera 7 of the base unit 2. The image generated there reproduces the intensity and angular distribution of the reflected light beams 10′ as a consequence of the surface plasmon resonance and is subsequently processed further by means of the electronic control and evaluation means 4. The result is then shown on the signal display 8.

FIG. 2 shows a further optical sensor unit 21 in which a prism stump 22 is used, the side surfaces 23, 24 of which also have a parabolic curvature. On the outside, the prism stump 22 has a well-reflecting layer 25, both around the side surfaces 23, 24 as well as in the partial area 26, 27 of the base surface 28, onto which the light beams 10, 10′ are reflected.

FIG. 3 shows an optical sensor unit 31 with a prism stump 32, whose inclined side surfaces 33, 34 have the same spherical curvature. In this case, in order to ensure a focussing of the light beams on the central area 35 between the two side surfaces 33, 34 on the upper surface 37 opposite the base surface 36, it is necessary that the spherical centres, designated 38, 39, of the curved side surfaces 33, 34 lie outside the symmetry axis 40, but symmetrically around it.

Naturally, the invention is not limited to the above described working example. Thus, FIG. 4 shows an SPR sensor 100 which again consists of a base unit 2 and an optical sensor unit 103 whereby, in accordance with the invention, a focussing lens 120, 121 is arranged integrated in the prism in each of the areas 118, 119 of the base surface 133 of the prism stump 112, where the light beams 10, 10′ are coupled in and/or out. The light beam 10 coupled in via the base surface 113 is therefore reflected at the side surface 115 of the prism and the base surface 113 which is also provided with a well-reflecting layer 117, and is focussed on a focal point located centrally on the upper surface 114 of the prism stump 112, and in the area of the focal point a thin metal film 122 of gold is arranged to form a measuring surface. The thin metal film 122 is brought into contact on the outside with and analyte 123 (e.g. located in a measuring cell).

FIG. 5 shows an SPR sensor 130 with an optical sensor unit 131 which also comprises a prism 132 with focussing side surfaces 133, 134. In order to increase the sensitivity of the sensor 130, a (isogonal) retroreflector 135 is arranged on the exit side of the prism 132. In this arrangement, the light beam passes through the prism 132 twice because of the reflection at the retroreflector 135, and the image to be analysed is reflected into a camera 137 by means of a beam splitter 136.

This arrangement is advantageous when the plasmon resonance is not pronounced, but a clear SPR signal still has to be generated, for example in the presence of a too thin adsorbate film of the measuring surface 138.

The retroreflector 135 can be arranged either externally as a separate unit or for example be applied directly on the exit side surface of the prism 132, e.g. as a retroreflector foil.

Furthermore, this use of a retroreflector is in no way limited to the use of prisms with focussing side surfaces, but can for example also be used in arrangements in which the focussing is not (or not solely) provided by correspondingly shaped areas of the prism, but instead by means of a lens coupled in front of the prism. In this case, the beam splitter is then arranged between the focussing external lens and the prism.

Also in arrangements without a retroreflector, it is possible to use a prism without focussing partial areas. The focussing of the light beam onto the measuring surface is also in this case provided by means of external lenses. The focussed light beam is then deviated (focussed) further onto the measuring surface via the mirror-coated side surfaces of the prism. In such arrangements, it has been shown to be advantageous that the prism is arranged in such a manner that a fraction of the focussed beam propagates inside the prism, but that the majority of the light beam propagates outside the prism. In particular, through selection of a suitable lens focal length and lenses or beam diameters, respectively, it is ensured that the thickness of the prism can be kept small and in the area of 1-3 mm. Both dimensions determine the aperture angle of the incoming beam which should be in the range of 10 to 20 degrees. The distance of the base surface of the prism from the principal plane of the lens is given from the focal length of the lens minus the optical path inside the prism until the focal point on the measuring surface.

List of Reference Numbers

1 Surface plasmon resonance sensor, SPR sensor
2 Base unit
3 Optical sensor unit
4 Control and evaluation means
5 Power supply unit
6 Light source, light diode
7 Camera
8 Signal display
9 Polarizer
10 Light beams
10′ Light beams
11 Collimator lens
12 Prism
13 Base surface
14 Limitation surface
15 Reflecting layer
16 (First) side surface, area
17 Focal point
18 Metal film, measuring surface
19 Measuring cell, analyte, sample
20 (Second) side surface, area
21 Optical sensor unit
22 Prism, prism stump
23, 24 Side surfaces, areas
25 Reflecting layer
26, 27 Partial areas
28 Base surface
29 Measuring surface
30 Upper surface
31 Optical sensor unit
32 Prism, prism stump
33, 34 Side surfaces, areas
35 Central area
36 Base surface
37 Upper surface
38, 39 Sphere centres
40 Symmetry axis
100 Surface plasmon resonance sensor, SPR sensor
103 Optical sensor unit
112 Prism, prism stump
113 Base surface
114 Upper surface
115 Side surface
117 Reflecting layer, partial area
118, 119 Areas
120, 121 Lenses
122 Metal film, measuring surface
123 Analyte, sample
130 Surface plasmon resonance sensor, SPR sensor
131 Optical sensor unit
132 Prism, prism stump
133, 134 Side surfaces, areas
135 Retroreflector
136 Beam splitter
137 Camera
138 Measuring surface

1. Surface plasmon resonance sensor comprising a base unit (2) with a light source (6) for generating light beams (10), and an optical sensor unit (3; 21; 31; 103; 131) for exciting surface plasmons and having a measuring surface (18; 29; 122; 138) formed by a metal film which can be brought into contact with a sample (19; 123) to be measured, whereby the optical sensor unit (3; 21; 31; 103; 131) comprises a solid, optically transparent element (12; 22; 32; 112; 132) at whose inclined, externally mirror-coated side surfaces (16, 20; 23, 24; 33, 34; 115; 133, 134) collimated light beams (10′) which are coupled into or out of the element (12; 22; 32; 112; 132) via the base surface (13; 28; 36; 113) are deviated, and whereby the light beams (10, 10′) which are coupled in and out proceed perpendicular in relation to the base surface (13; 28; 36; 113) of the element (12; 22; 32; 112; 132), characterized in that areas (16, 20; 23, 24; 33, 34; 118, 119; 133, 134) of the element (12; 22; 32; 112; 132) are shaped in such a way that the light beams (10) coupled in via the base surface (13, 113) are focussed onto the measuring surface (18; 29; 122; 138), and/or the reflected light beams (10′) emanating from the measuring surface (18; 29; 122; 138) are converted into collimated light.

2. Surface plasmon resonance sensor according to claim 1, characterized in that the inclined side surfaces (16, 20; 23, 24; 33, 34) of the element (12; 22; 32) have a convex curvature at least in the deviating areas for the light beams (10, 10′) so that the light beams (10) coupled in via the base surface (13; 28; 36) are focussed onto the measuring surface (18), and the reflected light beams (10′) emanating from the measuring surface (18) are converted into collimated light.

3. Surface plasmon resonance sensor according to claim 2, characterized in that the inclined side surfaces (16, 20; 23, 24) of the element (12; 22) have a parabolic curvature at least in the deviating areas.

4. Surface plasmon resonance sensor according to claim 2, characterized in that the inclined side surfaces (33, 34) of the element (32) have a spherical curvature at least in the optical beam directing areas.

5. Surface plasmon resonance sensor according to claim 4, characterized in that the spherical curvature of the optical beam directing areas of the two opposed side surfaces (33, 34) is selected so that the spherical centres (38, 39) of these curvatures lie outside their symmetry axis (40), but symmetrically around it.

6. Surface plasmon resonance sensor according to claim 1, characterized in that a focussing lens (120, 121) integrated into the element (112) is arranged in each of the areas (118, 119) of the base surface (113) of the element (112) via which the light beams are coupled in and/or out, so that the light beams (10) coupled in via the base surface (113) and reflected at the side surfaces (115) of the element (112) are focussed onto the measuring surface (122), and/or the reflected light beams (10′) emanating from the measuring surface (122) are converted into collimated light.

7. Surface plasmon resonance sensor according to claim 6, characterized in that the inclined side surfaces (115) of the element (112) are planar at least in the deviating areas.

8. Surface plasmon resonance sensor according to claim 6, characterized in that the inclined side surfaces (115) of the element (112) have a parabolic or spherical curvature at least in the deviating areas, so that the focussing effect of the lens (120, 121) and the focussing effect of the curved side surfaces (16, 20) together cause a focussing of the light beams (10) on the measuring surface.

9. Surface plasmon resonance sensor according to claim 1, characterized in that the element (22; 32; 112; 132) is a prism stump having base surfaces (28; 36; 113) and upper surfaces (30; 37; 114) arranged parallel with one another.

10. Surface plasmon resonance sensor according to claim 9, characterized in that the base surface (28; 36; 113) and/or the upper surface (30; 37; 114) of the prism stump (22; 32; 112; 132) is/are mirror-coated at least in a partial area (26; 27; 117) in such a manner that the focussed light beams emanating from the side surfaces (23, 24; 33, 34; 115; 133, 134) arrive at the measuring surface (29; 122; 138) after at least one reflection.

11. Surface plasmon resonance sensor according to claim 1, characterized in that the light source (6) of the base unit (2) is a light source generating a monochromatic beam.

12. Surface plasmon resonance sensor according to claim 1, characterized in that a polarizer (9) is coupled after the light source (6) in the base unit (2).

13. Surface plasmon resonance sensor according to claim 1, characterized in that the measuring surface (18; 29; 122; 138) is located centrally on the base surface (13; 28; 36; 113) of the element or prism stump, or, in case of the use of a prism stump (22; 32; 112; 132), centrally on the upper surface (30; 37; 114) opposite the base surface (28; 36; 113).

14. Surface plasmon resonance sensor according to claim 1, characterized in that the element (12; 22; 32; 112; 132) consists of plastic, glass or sapphire.

15. Surface plasmon resonance sensor according to claim 1, characterized in that a retroreflector (135) is arranged on the exit side of the element (132) of the SPR sensor (130), and a beam splitter (136) and a camera (137) are arranged on the entry side of the element (132), so that the light beam coupled into the element (132) passes through the element twice due to the reflection at the retroreflector (135), and the image to be analysed is reflected into a camera (137) by means of a beam splitter (136).
